(19) United States
(12) Patent Application Publication
(10) Pub. No.: US 2009/0170378 A1
(43) Pub. Date: Jul. 2, 2009

(54) Contact Member and Electrical Connector

(76) Inventor: Yohei Harada, Tokyo (JP)

Correspondence Address: BARLEY SNYDER, LLC, 1000 WESTLAKES DRIVE, SUITE 275, BERWYN, PA, 19312, US

(21) Appl. No.: 12/342,356

(22) Filed: Dec. 23, 2008

(30) Foreign Application Priority Data
Dec. 28, 2007 (JP) 2007-339191

(51) Int. Cl. H01R 13/514; H01R 13/52

(52) U.S. Cl. 439/701; 439/282

(57) ABSTRACT

There is provided a contact member that is formed by folding a contact beam and nevertheless has a decreased width. A contact member having a base, a first securing leg formed by bending one end of the base in the width direction of the base, a second securing leg formed by bending the other end of the base in the width direction, a contact beam consisting of an extension portion that extends from the base and is arranged between the securing legs and a folded portion. The folded portion is arranged in order to face the base, by being folded from the extension portion. The contact member additionally having a connection portion capable of securing to a printed wiring board. The connection portion is provided on the first securing leg.

### CROSS-REFERENCE TO RELATED APPLICATIONS

This is application claims the benefit of the filing date under 35 U.S.C. §119(a)-(d) of Japanese Patent Application No. 2007-339191, filed Dec. 28, 2007.

### FIELD OF THE INVENTION

The present invention relates to a contact member and an electrical connector (hereinafter, referred simply to as a connector) using the contact member.

### BACKGROUND

Cantilever contact members having a contact portion for contact with a mating conductor and a connection portion for connection with, for example, a printed wiring board (hereinafter, referred simply to as a wiring board), are readily known. One example of such a contact member is explained with reference to FIGS. 6 to 9.

A contact member 100 includes a base 101, a contact beam 103, and a connection portion 105 as principal elements. The contact beam 103 includes an extension portion 103a extending from one end of the base 101 and a folded portion 103b, formed by being folded from the extension part 103a. At both ends, press-fit protrusions 102 (102a to 102d) are formed in the width direction of the base 101. Additionally, a contact part 104 is formed at the tip end of the contact beam 103.

As shown in FIG. 7, the contact member 100 is secured in a housing 110, to provide a connector 200. As shown in FIGS. 8A and 8B, the contact member 100 is housed in a contact receiving area 111, which is formed in the housing 1 10. The press-fit protrusions 102 (hereinafter, referred simply to as protrusions 102) are press-fit in the housing 110, specifically in the contact receiving area 111, by which the contact member 100 is secured to the housing 110. In this case, a part, ranging from the extension portion 103a to the contact portion 104, functions effectively as a spring.

When the connector 200 is electrically connected to a mating equipment 300, as shown in FIGS. 9A to 9C, the mating equipment 300 is arranged so that the contact portion 104 and a conductor portion 301 of the mating equipment 300 face to each other. The mating equipment 300 may then be pushed toward the connector 200.

As the mating equipment 300 is further pushed further toward the connector 200, the contact part 104 meets the conductor part 301 and the contact beam 103 becomes resiliently deformed. By this deformation, the contact portion 104 is pressed against the conductor portion 301. In order to ensure an electrical connection between the contact portion 104 and the conductor portion 301, the contact portion 104 should be prepared having high yield strength. The height of the contact portion 104 is defined as the direction in which the contact portion 104 is displaced.

One applied example of the connector 200 is a cellular phone handset, which utilizes a battery cell as the mating equipment 300. Since cellular phones have become smaller, so have the connectors 200, as well as the contact members 100 being used in those cellular phones. Specifically, the base 101 width of the contact member 100 has become smaller, including the displacement direction (this size is called the height) of the contact portion 104.

As the components become smaller, it is difficult to increase the resilient displacement of the contact part 104, because a cantilever contact beam, the length functioning effectively as a spring (hereinafter, referred to as a spring length), becomes shorter. Therefore, a shorter cantilever contact beam deforms rather easily when being displaced. To overcome this problem in conventional contact members 100, the spring length is substantially increased by folding the contact beam 103. In the case where the spring length is merely increased, for example, the contact beam 103 can be folded twice. However, even this configuration is disadvantageous when the contact member 100 requires smaller design because of increased height.

The cantilever contact member, in which the contact beam 103 is formed so as to be folded with respect to the base, is also described in Patent Documents 1 and 2.

Patent Document 1: Japanese Patent Laid-Open No. 2000-58161 (FIG. 1)

Patent Document 2: Japanese Patent Laid-Open No. 2002-25730 (FIG. 1)

In the conventional contact member 100, the connection portion 105 and the extension portion 103a of the contact beam 103 are arranged in parallel and found on the same plane. Therefore, the conventional contact member 100 has greater width, by that of the connection portion 105 as well as the base 101.

### SUMMARY

It is an object of the present invention to provide a contact member that is formed by folding a contact beam and nevertheless has limited width. Further, another object of the present invention is to provide an electrical connector provided with such a contact member, which is advantageous for smaller applications.

A contact member having a base, a first securing leg formed by bending one end of the base in the width direction of the base, a second securing leg formed by bending the other end of the base in the width direction, a contact beam consisting of an extension portion that extends from the base and is arranged between the securing legs and a folded portion. The folded portion is arranged in order to face the base, by being folded from the extension portion. The contact member additionally having a connection portion capable of securing to a printed wiring board. The connection portion is provided on the first securing leg.

### BRIEF DESCRIPTION OF THE DRAWINGS

The invention will be explained in greater detail in the following with reference to embodiments, referring to the appended drawings, in which:

FIGS. 1A and 1B are perspective views of a connector in accordance with an embodiment of the present invention;;

FIGS. 2A and 2B are perspective views of a contact member in accordance with an embodiment of the present invention;

FIGS. 3A and 3B are views showing a connector in accordance with an embodiment of the present invention;

FIG. 4 is an exploded perspective view of a connector in accordance with an embodiment of the present invention;

FIGS. 5A to 5C are views showing a state in which a connector in accordance with an embodiment of the present invention is connected to a battery cell;

FIGS. 6A and 6B are perspective views showing one example of a conventional contact member;

FIG. 7 is a perspective view showing one example of a conventional connector provided with the contact members shown in FIGS. 6A and 6B;

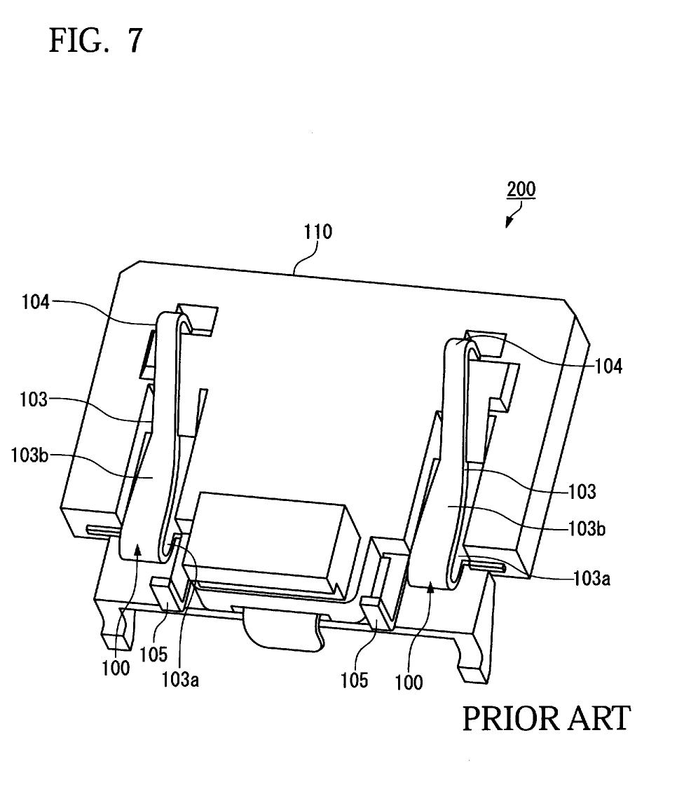

FIGS. 8A and 8B are partial sectional views of the connector shown in FIG. 7; and

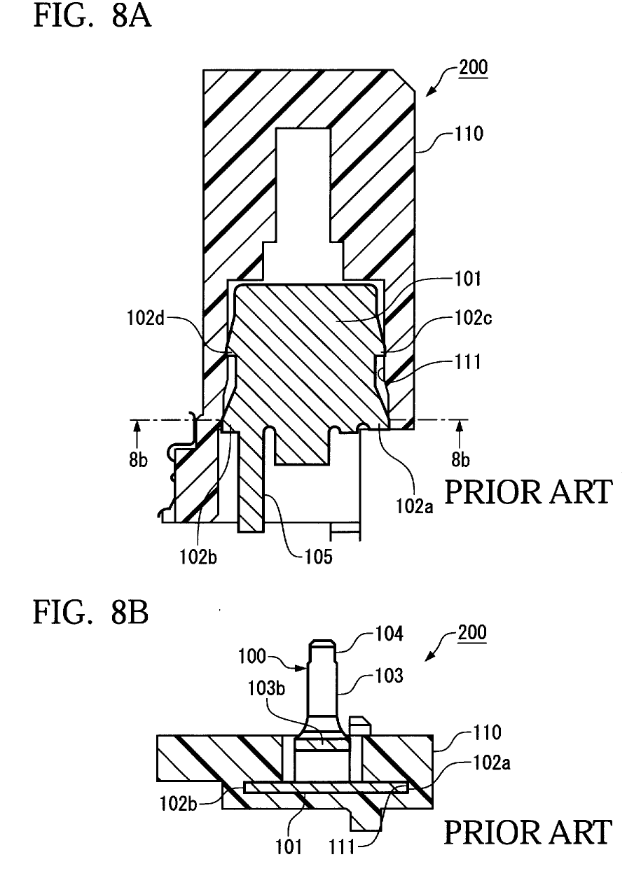

FIGS. 9A to 9C are views showing a state in which a conventional connector is connected to a mating equipment.

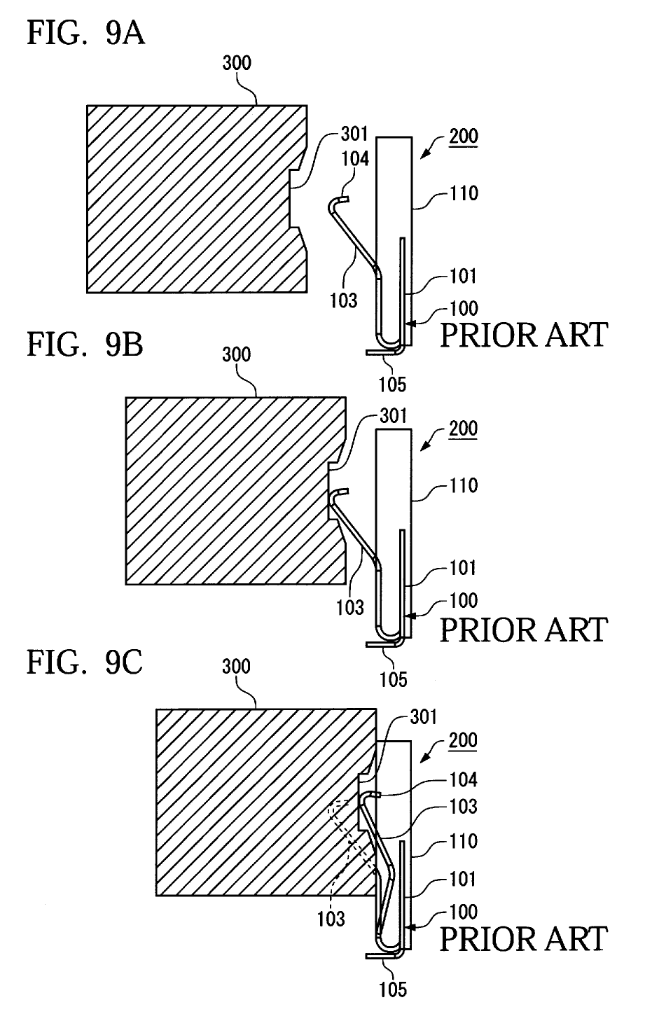

### DETAILED DESCRIPTION OF THE EMBODIMENT(S)

An embodiment of the present invention will now be described in detail with reference to the accompanying drawings.

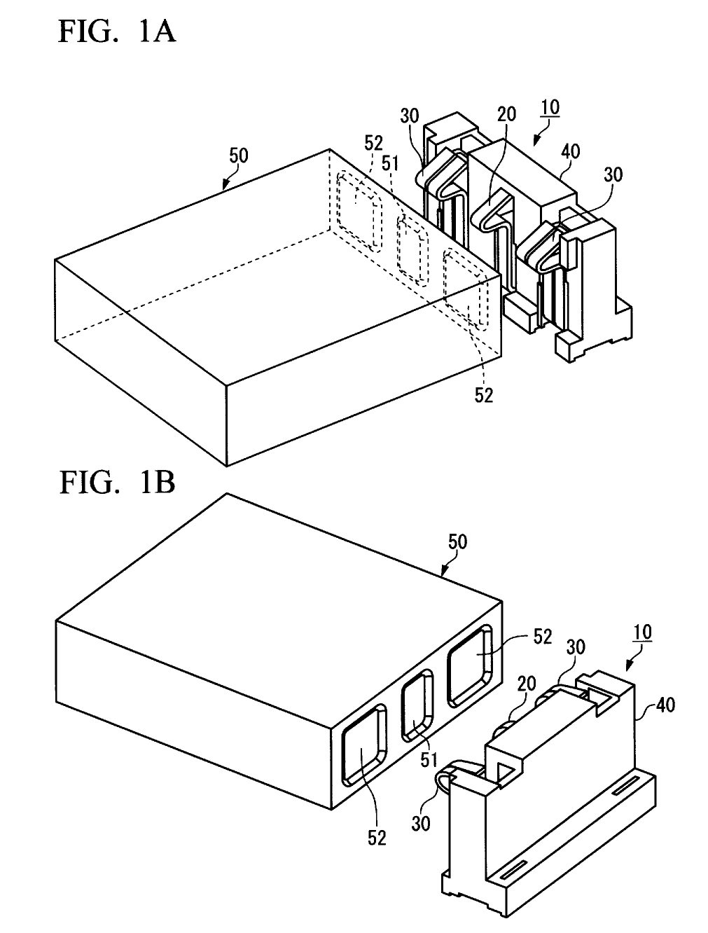

The embodiment shown in FIGS. 1A and 1B relates to a connector 10 for electrically connecting (hereinafter, referred simply to as connecting), for example, a battery cell 50 of a cellular phone handset and a printed wiring board, not shown, to each other.

The connector 10 includes contact members 20, 30 and a housing 40 for holding the contact members 20, 30. The contact member 20 is connected to a first conductor pad 51 of the battery cell 50, and the contact member 30 is connected to the second conductor pads 52 of the battery cell 50. Each of the contact members 20, 30 are generally formed integral by stamping out a copper alloy sheet, which has high resiliency and electric conductivity. The housing 40 is generally formed integral through injection molding a resin of insulative material.

The embodiment shown features the contact members 20, 30. The contact member 30 has almost the same construction as that of the contact member 20, except that it has two contact beams. Therefore, hereunder, a specific description of the contact member 30 is omitted.

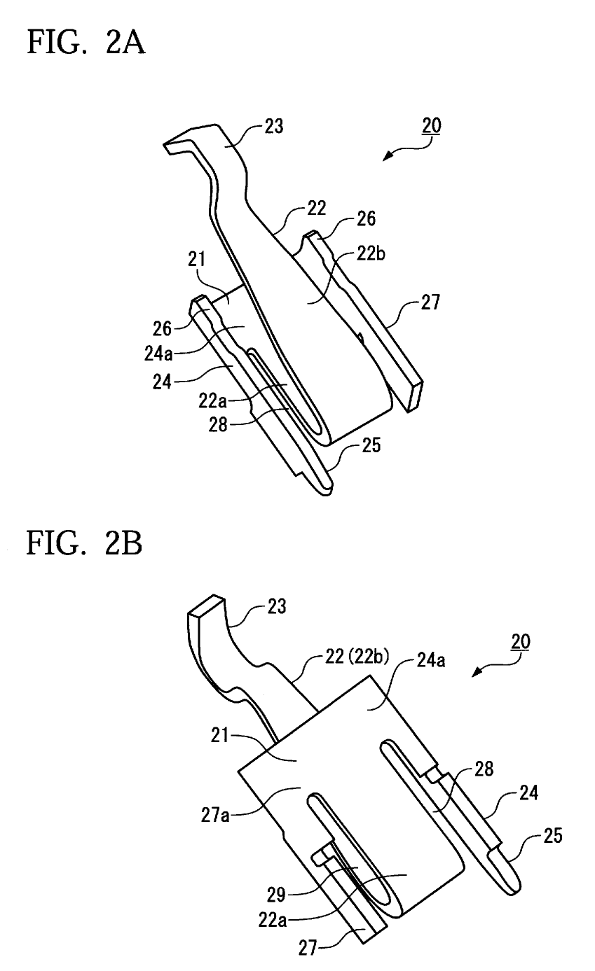

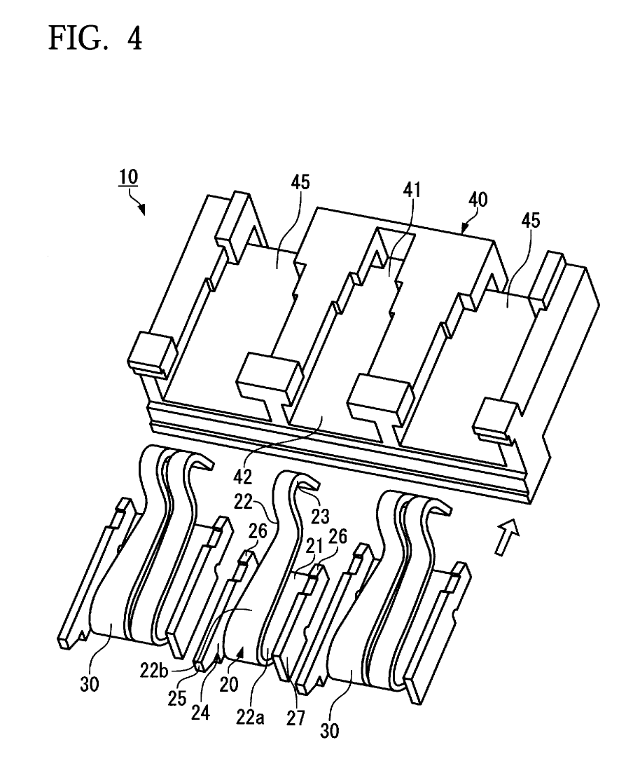

First, the contact member 20 is described with reference to FIGS. 2A and 2B. The contact member 20 is inserted into a housing 40 in a direction indicated by an arrow mark shown in FIG. 4. It should be noted for the following description that the side inserted first into the housing 40 is a front end, and the opposite side as a rear end.

The contact member 20 has a flat plate shaped base 21 and a contact beam 22. The contact beam 22 includes an extension portion 22a and a folded portion 22b. The extension portion 22a extends toward the rear end of the housing 40 and is positioned on the same plane as the base 21. The folded portion 22b is formed by folding the rear end of the extension portion 22a and is arranged between securing legs 24 and 27, which will be described later. Additionally, the folded portion 22b is arranged in such a way as to face the base 21. At the tip end of the contact beam 22 (folded portion 22b), a contact portion 23 is prepared with a curvature and having a U shape. The contact portion 23 meets with the conductor pad 51 of the battery cell 50.

The contact member 20 includes securing legs 24 and 27, which are formed by bending both sides of the base 21. The sides of the base 21 are bent is such a way that the securing legs 24 and 27 are turned toward the contact beam 22 side. The height of the securing legs 24 and 27 need only be a height that matches a predetermined mechanical strength. Therefore, the height of the securing legs 24 and 27 need not be made larger than the height of the folded portion 22b of the contact member 20, so long as the height of the securing legs 24 and 27 are high enough to match a predetermined mechanical strength. In the embodiment shown, the height of the contact member 20 is not any larger than the height of the conventional contact member 100. The securing legs 24 and 27, when bent, should be 90 degrees relative to a plane of the base 21. The securing legs 24 and 27 are connected to the base 21 via connecting portions 24a and 27a, respectively, ranging from the front end to a predetermined position. Notches 28 and 29 are prepared between the securing legs 24 and 27 and the base 21, respectively, in a range from the predetermined position toward the rear end. The notches 28 and 29 are provided because the spring length of the contact beam 22 is increased.

A connection portion 25 is provided on the rear end side of the first securing leg 24, and is formed in order to project from the rear end of the second securing leg 27. The connection portion 25 may be provided on the second securing leg 27 as well.

On the upper end faces, that is, the end faces opposed to the base 21, of the securing legs 24 and 27, press-fit protrusions 26 (hereinafter, referred simply to as protrusions 26) are formed. The protrusions 26, which are formed at the front ends of both securing legs 24 and 27, are press fit into receiving holes 44 formed in the housing 40.

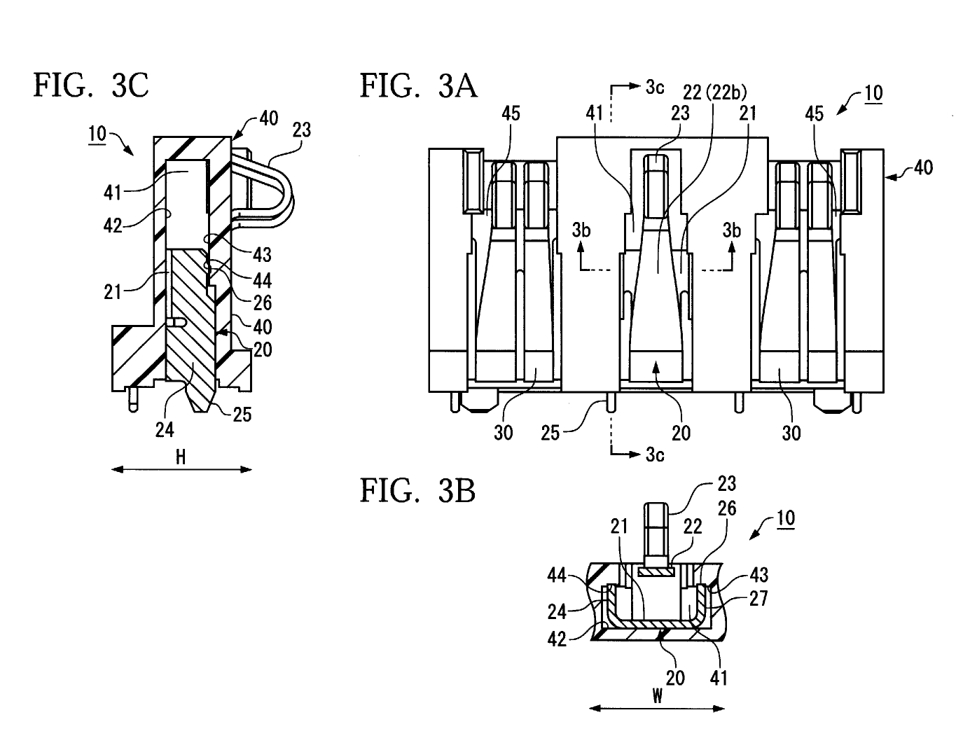

As shown in FIGS. 3 and 4, the housing 40 is provided with a first contact receiving area 41 for retaining the primary contact member 20 and a second contact receiving area 45 for retaining the secondary contact members 30. In FIGS. 3B and 3C, a double-headed arrow H indicates the height direction, and a double-headed arrow W indicates the width direction.

The housing 40 is formed with a lower wall 42 and an upper wall 43 that define the first contact receiving area 41. The lower wall 42 has a width that is approximately equal to the width of the contact member 20, and is provided in almost the whole region of the first contact receiving area 41. The upper wall 43 is provided in regions corresponding to the securing legs 24 and 27 on both sides of the first contact receiving area 41, in the state in which the contact member 20 is held in the housing 40. The upper wall 43 is formed with the receiving holes 44 in which the protrusions 26 of the securing legs 24 and 27 are press fit.

The contact members 20, 30 are inserted into the housing 40 in the direction indicated by the arrow mark shown in FIG. 4. The protrusions 26 of the securing legs 24 and 27 prevent the contact member 20 from coming off the housing 40 because the protrusions 26 are press fit into the receiving holes 44 of the housing 40 when the contact member 20 is housed in the first contact receiving area 41. In this state, the lower surface of the base 21 of the contact member 20 is in contact with the lower wall 42, and the upper end faces of the securing legs 24 and 27 are in contact with the upper wall 43 (see FIGS. 3B and 3C). Therefore, the lower wall 42 functions as a holding surface for the base 21, and the upper wall 43 functions as a holding surface for the securing legs 24 and 27. The three surfaces of the contact member 20 are in contact with the housing 40, so that the contact member 20 is securely held in the housing 40.

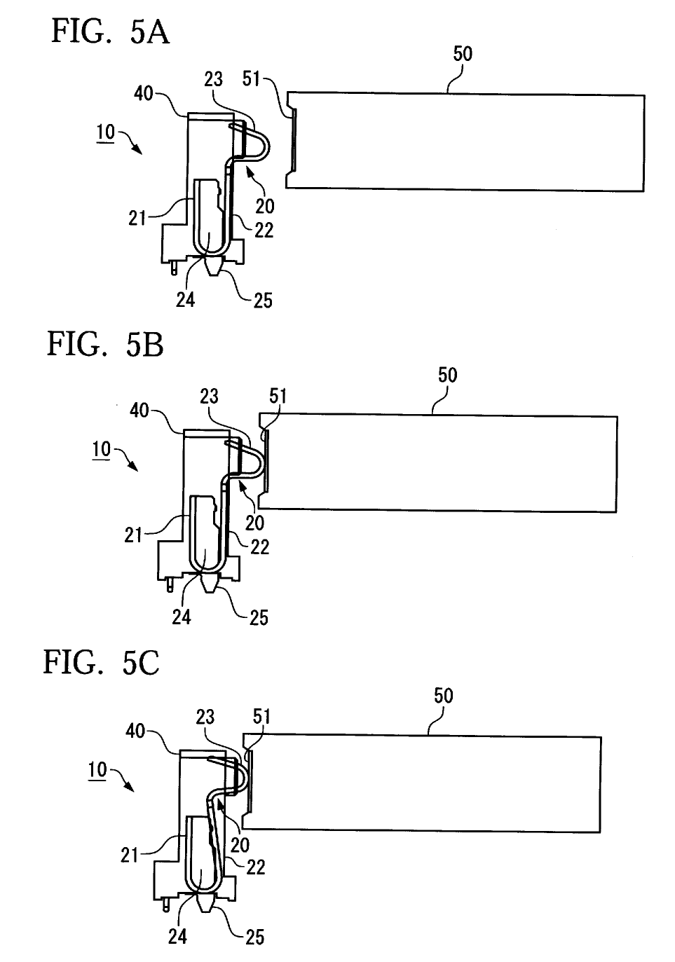

As shown in FIGS. 5A to 5C, the battery cell 50 is pressed against the connector 10 during a state in which the contact member 20 faces to the conductor pad 51 of the battery cell 50, and the contact portion 23 of the contact member 20 is brought into contact with the conductor pad 51. When the battery cell 50 is further pressed to a predetermined position, the connector 10 is secured. At this time, the contact beam 22 is resiliently deformed, and by the reaction force of this deformation, the contact portion 23 is pressed against the conductor pad 51.

Next, the operation and effects of this embodiment are described.

In the embodiment shown, the contact member 20 is provided with the securing legs 24 and 27 on both sides of the base 21, and is provided with the connection portion 25 on the first securing leg 24. Therefore, the width of the contact member 20 is narrower than the width of a conventional contact member 100, by a size corresponding to the heights of the securing legs 24 and 27. The conventional contact member 100 has a connection portion 105 arranged in parallel and to the side of a contact beam 103 (an extension portion 103a).

As described below, the configuration of the contact member 20, in the embodiment shown, is suitable for increasing the spring length.

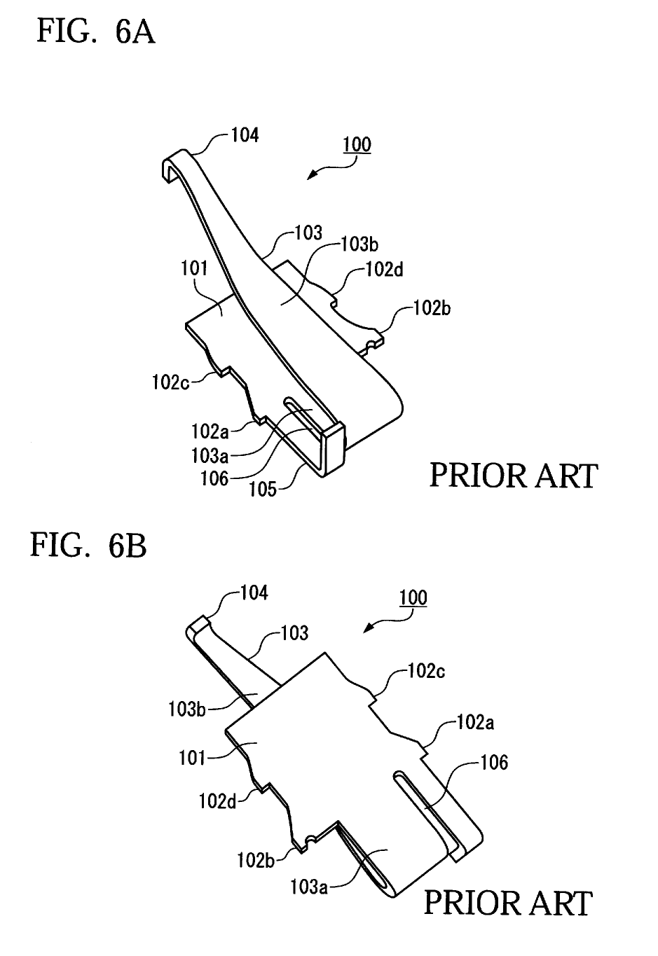

In order to increase the spring length of the conventional contact member 100, shown in FIGS. 6A and 6B, a notch 106 is formed between the soldering portion 105 and the base 101, wherein the notch 106 only extends to the front end side. However, if the notch 106 is extends to between the protrusions 102a and 102b, which are opposed to each other, the overall rigidity of the base 101 decreases. Therefore, the contact member 100, in such a situation, is not firmly fixed, even if being inserted into the cavity 111. The contact member 100 may easily come off the housing 110. Thus, when a force is applied from the housing 110 along the width direction of the conventional contact member 100, the notch 106 cannot extend to a point between the protrusions 102a and 102b.

In contrast, for the contact member 20 of the present invention, the lower surface of the base 21 is held by the lower wall 42, and the upper faces of the securing legs 24 and 27 are held by the upper wall 43. That is to say, the direction in which the contact member 20 is held by the housing 40 is the height direction (see FIGS. 3B and 3C). In this configuration, even if the notches 28 and 29 of the contact member 20 are lengthened, rigidity in the height direction of the base 21 and the securing legs 24 and 27 is well maintained. Even if the notches 28 and 29 are lengthened, a securing force required for the contact member 20 in the housing 40 is not lowered. Therefore, the contact member 20 is well secured by both the housing 40 and the spring length. In other words, the positions at which the protrusions 26 are provided are not restricted by the spring length. There is a greater degree of freedom in designing the contact member 20.

It can be said that the contact member 20, in accordance with the embodiment shown, is held by the housing 40 more securely than the conventional contact member 100.

When the connector 10 is positioned to a predetermined connecting state, with respect to the battery cell 50 (see FIG. 5C), the base 21 of the contact member 20 receives a clockwise rotational force on the front end (the protrusion 26). The direction of this rotational moment directly relates to the height direction of the contact member 20 (see FIG. 3C). The contact member 20, in accordance the embodiment shown, in addition to the upper end faces of the securing legs 24 and 27, and the lower surface of the base 21 are held by the lower wall 42 of the housing 40. That is to say, the movement in the height direction of the base 21 is constricted. Even if the base 21 receives the above-described rotational moment, the base 21 does not move in the clockwise direction.

As described above, and according to the present invention, the width of the cantilever contact member 20, provided with the folded contact beam 22, can be decreased without decreasing the spring length thereof Therefore, the size of the contact member 20 can be made smaller while the same spring length is obtained. Additionally, according to the present invention, the displacement of the contact member 20, more specifically, of the contact part can be prevented, so that an appropriate connection with respect to the mating equipment can be well maintained.

The securing legs 24 and 27, in accordance the embodiment shown, are bent and turned toward the contact beam 22 side. However, it is possible to have the securing legs 24 and 27 bent and turned to an opposite side, the side away from the contact beam 22. In this case, as well, the width of the contact member 20 can be decreased. If the securing legs 24 and 27 are formed on the side on which the contact beam 22 is folded, like the contact member 20 of embodiment shown, the width of the contact member 20 can be decreased without increasing the height thereof. Therefore, this configuration is advantageous in minimizing the size of the contact member 20.

As discussed above, the bend angle of each of the securing leg 24 and 27, in accordance with embodiment shown, is 90 degrees. However, the bend angle thereof is not limited to this angle. For example, even if the bend angle is 30 degrees, the width of the contact member 20 can be decreased, as compared with the conventional contact member 100. However, the bent angle of 90 degrees is most advantageous in decreasing the width.

Further, the above description has been given of the contact member 20 having one contact beam 22. However, the present invention can be applied to not only the contact member 30 having two contact beams, but also a contact member having three or more contact beams.

Besides the above-described configurations, the configurations described in the above-described embodiment can be chosen, and further the configuration can be changed appropriately to any other configuration without departing from the spirit and scope of the present invention.

What is claimed is:

1. A contact member held in an insulative housing of an electrical connector, comprising:
a flat plate shaped base;
a first securing leg formed by bending one end of the base in a direction of the base width;
a second securing leg formed by bending an other end of the base in a direction of the base width;
a contact beam extending from the base and having an extension portion arranged between the first securing leg and the second securing leg; and a folded portion formed by being folded from the extension portion and arranged to face the base; and
a connection portion securable to a printed wiring board, and provided on at least one of the securing legs.

2. The contact member according to claim 1, wherein the first securing leg and the second securing leg are bent to a side on which the folded portion of the contact beam is arranged.

3. The contact member according to claim 1, wherein each of the securing legs are formed with a press-fit protrusion, which is press fittable in the housing, on an end face opposed to the base.

4. The contact member according to claim 2, wherein each of the securing legs are formed with a press-fit protrusion, which is press fittable in the housing, on the end face opposed to the base.

5. An electrical connector comprising:
a contact having a flat plate shaped base; a first securing leg formed by bending one end of the base in a direction of the base width; a second securing leg formed by bending an other end of the base in a direction of the base width; a contact beam extending from the base and having an extension portion arranged between the first securing leg and the second securing leg; a folded portion formed by being folded from the extension portion and arranged to face the base; and a connection portion securable to a printed wiring board, and provided on at least one of the securing legs; and,
a housing for receiving the contact.

6. The electrical connector according to claim 5, wherein the housing comprises:
a lower wall for securing the base and an upper wall which faces the lower wall and secures end faces of the securing legs; and
the base and the securing legs of the contact member are held between the upper and lower walls, whereby the contact member is secured within the housing.
